(19) United States
(12) Patent Application Publication
(10) Pub. No.: US 2012/0117093 A1
(43) Pub. Date: May 10, 2012

(54) METHOD AND SYSTEM FOR FUSING DATA

(76) Inventors: Oleg SHILOVITSKY, Brookline, MA (US); Anatoly Savin, Moscow (RU)

(21) Appl. No.: 13/290,863

(22) Filed: Nov. 7, 2011

Related U.S. Application Data
(60) Provisional application No. 61/411,158, filed on Nov. 8, 2010.

(51) Int. Cl. G06F 17/30

(52) U.S. Cl. 707/755; 707/E17.009; 707/E17.014

(57) ABSTRACT

A method and system for creating at least one structured snippet, comprising: performing processing associated with extracting data from multiple sources for at least one entity; performing processing associated with stitching the data together based on the semantic attributes of the data to create at least one structured snippet; and performing processing associated with suggesting at least one action or allowing at least one user to define at least one action related to the at least one structured snippet.

### CROSS-REFERENCE TO RELATED APPLICATIONS

This application claims the benefit of priority from provisional applications 61/411,158, filed Nov. 8, 2010, the entirety of which is incorporated by reference.

### BRIEF DESCRIPTION OF THE FIGURES

FIG. 1 illustrates a system for fusing data, according to an embodiment.

FIG. 2 illustrate a snippet, according to an embodiment.

FIG. 3 illustrates a table of objects, according to an embodiment.

FIGS. 4-11 and 13-24 illustrate various screen shots that may be utilized in a system for fusing data, according to an embodiment.

FIG. 12 illustrates a method for fusing data, according to an embodiment.

### DESCRIPTION OF EMBODIMENTS OF THE INVENTION

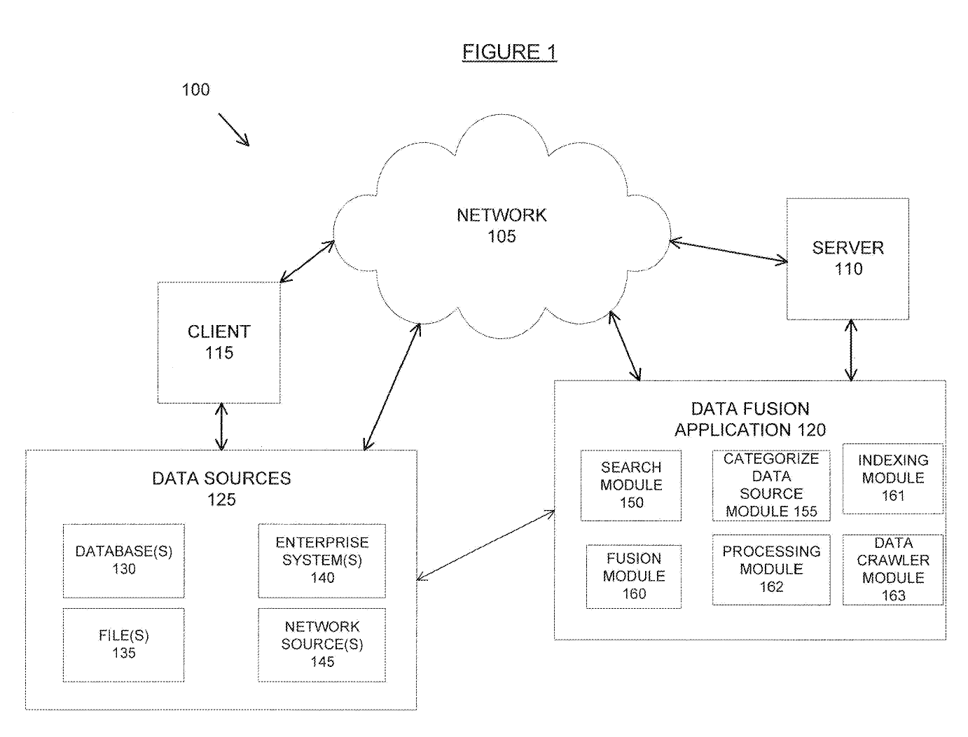

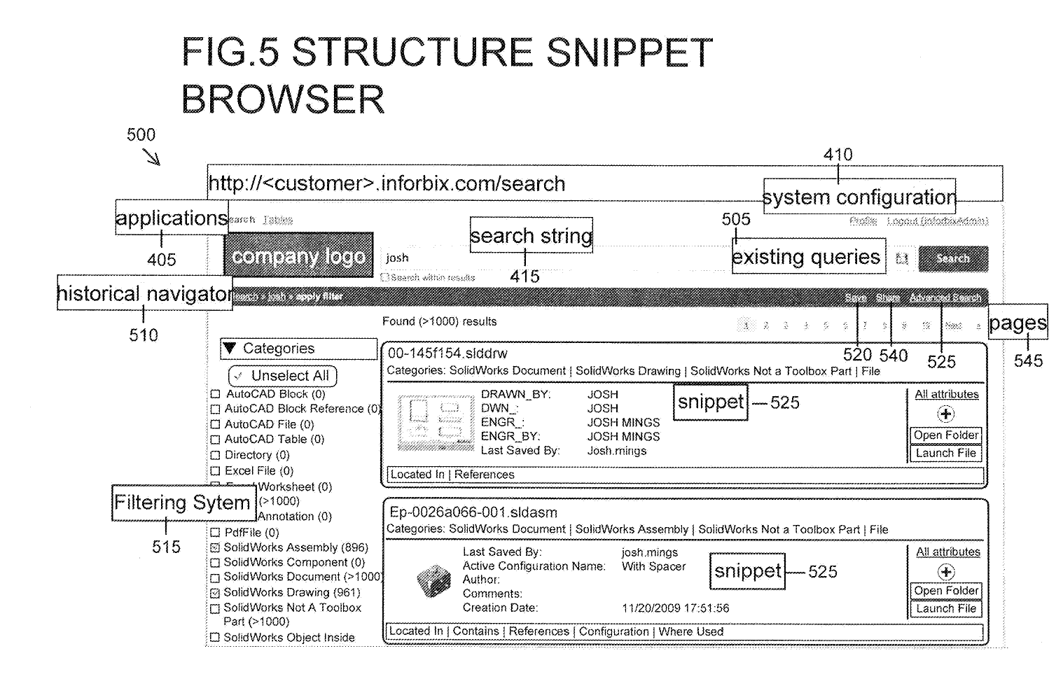

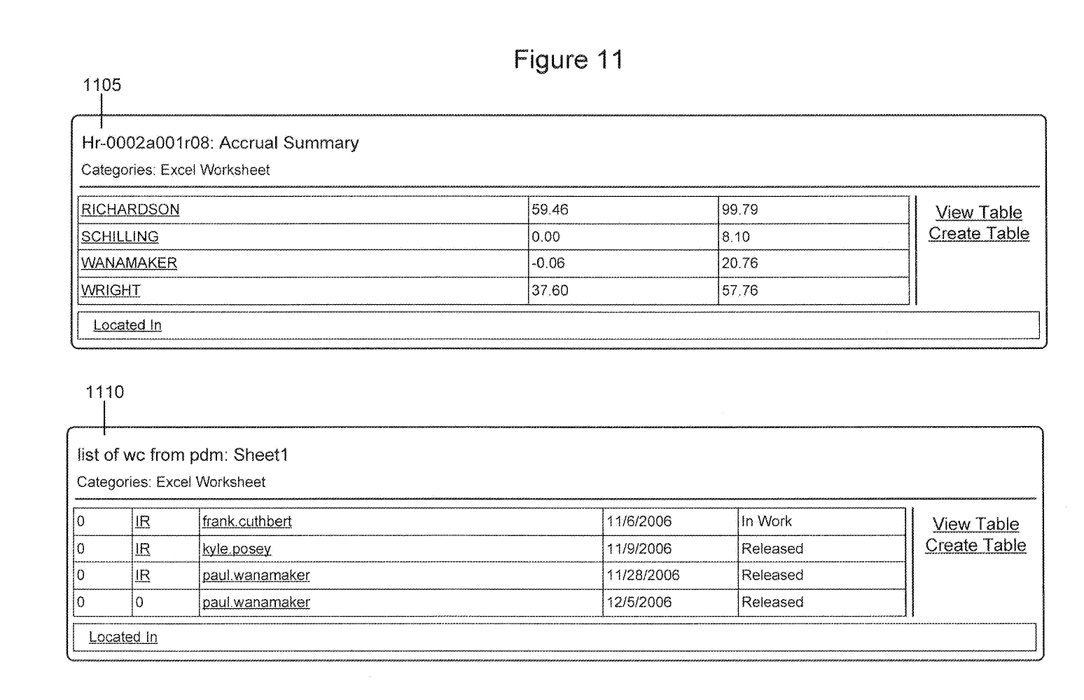

FIG. 1 illustrates a system 100 that can be utilized to fuse data, according to an embodiment. Snippets (e.g., content items) may represent information pulled from multiple systems and/or sources (e.g., applications (e.g., web applications, iphone applications), databases, excel files, documents, web sites, design files, enterprise systems, etc.) (e.g., Computer Aided Design (CAD) systems, Computer Aided Engineering (CAE) systems, Enterprise Resource Planning (ERP) systems, Customer Relation Management (CRM) systems, Supply Chain Management (SCM) systems). A snippet can present information about, for example, a product and/or service. A snippet can include ID information, category/attribute information, action information, or links to other related information, or any combination thereof. A snippet can be a structural object snippet (e.g., see the snippets in FIG. 5 along with their accompanying explanation) and/or a table snippet (e.g., see the snippets in FIG. 11 along with their accompanying explanation). A browser can be utilized to browse a set of snippets using a search string and/or attribute values.

The system 100 can be utilized to: search, display, navigate, and/or fuse data objects; establish relationships between the data objects; or allow the annotation of the data objects; or any combination thereof. Different navigation elements (e.g., filtering, links, controls) can help a user browse, filter, and visualize the data objects in a meaningful form.

FIG. 1 illustrates a network 105 connecting a server 110 and a client 115. The server 110 can communicate with a data fusion application 120 to search and fuse together information from data sources 125, which data sources 125 can be connected to various modules (e.g., data crawler module 163, search module 150, fusion module 160), which can be connected to a client 115. It should be noted that those of ordinary skill in the art will see that the data fusion application 120 can search the data sources 125 in multiple other manners, including the data fusion application 120 being used as an application on the client 115.

The data fusion application 120 can comprise a search module 150, a categorize data source module 155, an indexing module 161, a processing module 162, a data crawler module 163, or a fusion module 160, or any combination thereof. The data sources 125 can comprise: database(s) 130, file(s) 135 (e.g., CAD file, PDF file, EXCEL file, etc.), enterprise system(s) (e.g., PDM system, ERP system, PLM system, email system) 140, or network source(s) 145 (e.g., Web (e.g., cloud systems, online catalogues, applications), intranet systems, etc.), or any combination thereof.

In one embodiment, the search module 150 can search the data sources 125. For example, a word search can be done for any data source with the term “Boeing 747” in it. The results can be categorized by the categorize data source module 155. This categorization can help prepare the data so that the data can be fused together. The fusion module 160 can then fuse the found data together in a presentation, such as but not limited to, object snippets or a table of objects.

The indexing module 161 can index data extracted from multiple data sources. In some embodiments, any indexing library can be used for the indexing (e.g., LUCENE). For example, if a user searches for “door latch”, the indexing module 161 can index all of the results from this search. The indexing can prepare the search results so that any search results that can be used as snippets can be found.

In some embodiments, data can be extracted from data sources 125 and processed by data crawler module 163 to be presented as a list of triples (e.g., subject, predicate, object). For example: subject=document, predicate=document number, and object=actual document number and/or or reference to another subject. The indexing may also include attributes of the document (e.g., type of document (e.g., pdf, Assembly drawing), who created drawing, who approved drawing, who manufactured part in drawing, etc.).

The processing module 162 can pull the objects with snippet criteria and create snippets of these objects. For example, assume several objects with information on a particular part (e.g., door latch) have snippet information. The processing module 162 can pull these objects and use the snippet information to create a snippet for each object. Creating the snippet can include, but is not limited to: creating an ID for the snippet (e.g., a document can be assigned number 1345689.1); extracting attributes for the snippet from the indexing attributes, creating a preview for the snippet (e.g., a small picture of a piece of relevant information from the document); extracting links to other related objects and snippets using object properties from indexing; or identifying contextual actions (e.g., created by an administrator for different types of snippets) (e.g., if snippet is for a drawing, certain actions that a user can perform can be shown on the snippet; if the information is a page of written text from a document, other actions can be shown on the snippet); or any combination thereof.

The data crawler module 163 can search and read information from multiple data source types, for example: CAD (e.g., SOLIDWORKS, AUTODAD, etc.), PDM (e.g., AUTODESK VAULT), or ERP system (e.g., ORACLE E-BUSINESS SUITE), or any combination thereof.

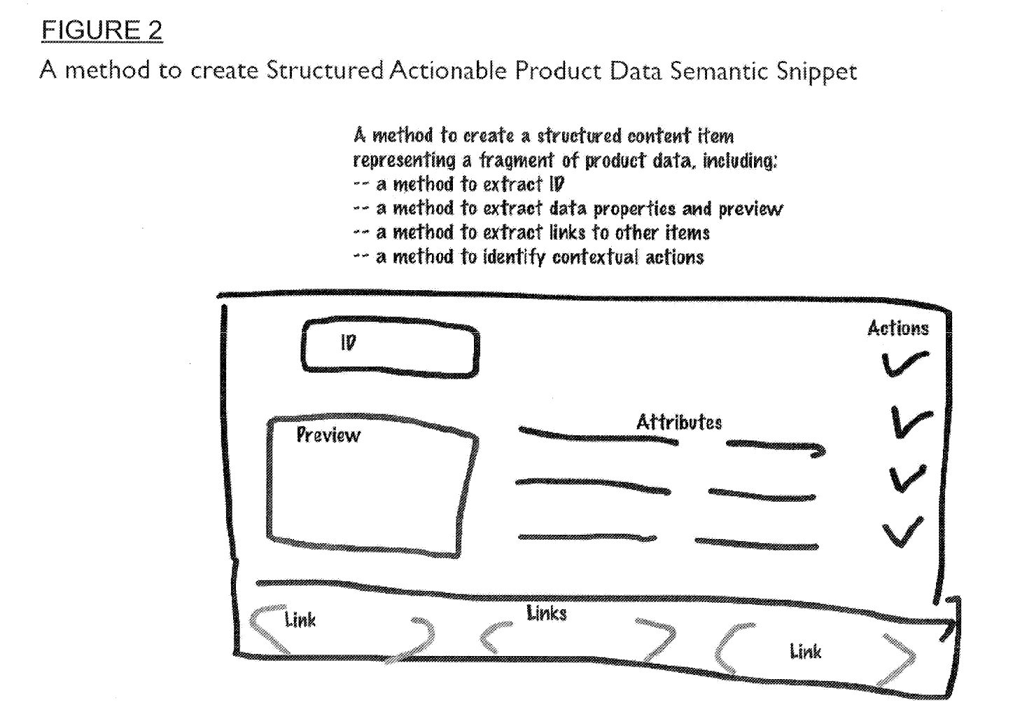

The system 100 can be operated with sets of data that can reside in multiple places (e.g., different files, different data storages). Data can be retrieved from multiple sources and stitched together in the snippet in a manner that follows a particular logic, as shown in the example of FIG. 2. A snippet, such as the one shown in FIG. 2, can represent information around or related to a specific subject. Information for the snippet can be found in multiple sources of information, such as: a drawing, a bill of material, a part description document, and an Excel document. As described above, the snippet can include: identification information (e.g., file name, part number), data attributes (this can also be referred to as category information), links, and actions that can be performed (e.g., a set of buttons used to run applications), and preview information (e.g., an image used to represent the snippet). In this way, information can be combined logically from different sources. This information can be logically stitched together in a form that can be referred to as semantically snipped or connected.

For example, in one embodiment, information utilized by a manufacturing company can be retrieved and stitched together. The information can include product information, design information, and/or cost information (e.g., cost information on wheels, engine) from multiple data sources from multiple divisions of the manufacturing company. The information can be stitched together in snippets and actions to be performed on the snippets can he listed. For example, the actions can include, but are not limited to: set task; send email; perform validation; open folder; start application; send document; compare data; or any combination thereof.

Thus, for example, information on an AIRCRAFT Interior 3D Assembly can be searched and stitched together in snippets. The identification information can be the AIRCRAFT Interior 3D Assembly. The attributes can include: Part Number, Description, Designer, Engineering, Manufacturing Engineering, and Project. The links can include: Where User, References, Manufacturing Assemblies, Orders, and Customers. The actions can include: Open in Solid Works, Goto Folder, View, and Set Task. The preview can include icons, links, etc. to other documents, such as pictures, videos, websites, etc.

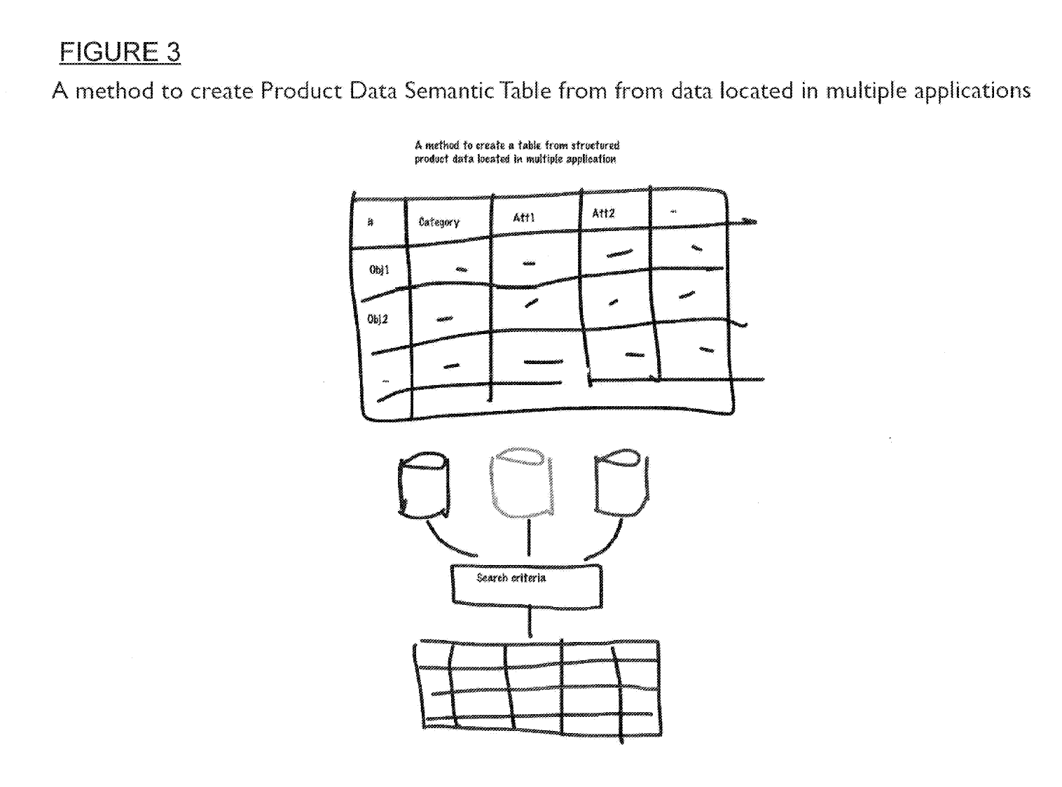

The data for the snippets can also be presented in a tabular format. FIG. 3 illustrates an example of a table of objects, according to one embodiment. The rows in the table can be used for different objects. The columns in the table can represent characteristics of the objects. For example, attribute 1 can belong to a first data source (e.g., object). Attribute 2 can belong to a second data source. The tabular format with the columns and rows can allow conclusions to be made about potential objects and potential characteristics of these objects.

For example, the table can be a “Table of Updated Drawings” for the last week. The different drawings can be listed as objects in the rows. The columns can include attributes (e.g., characteristics) of the objects, including, but not limited to: Drawing Numbers, Description, Designer, Engineering, Department, Project, Order, or Engineering Change Order (ECO), or any combination thereof.

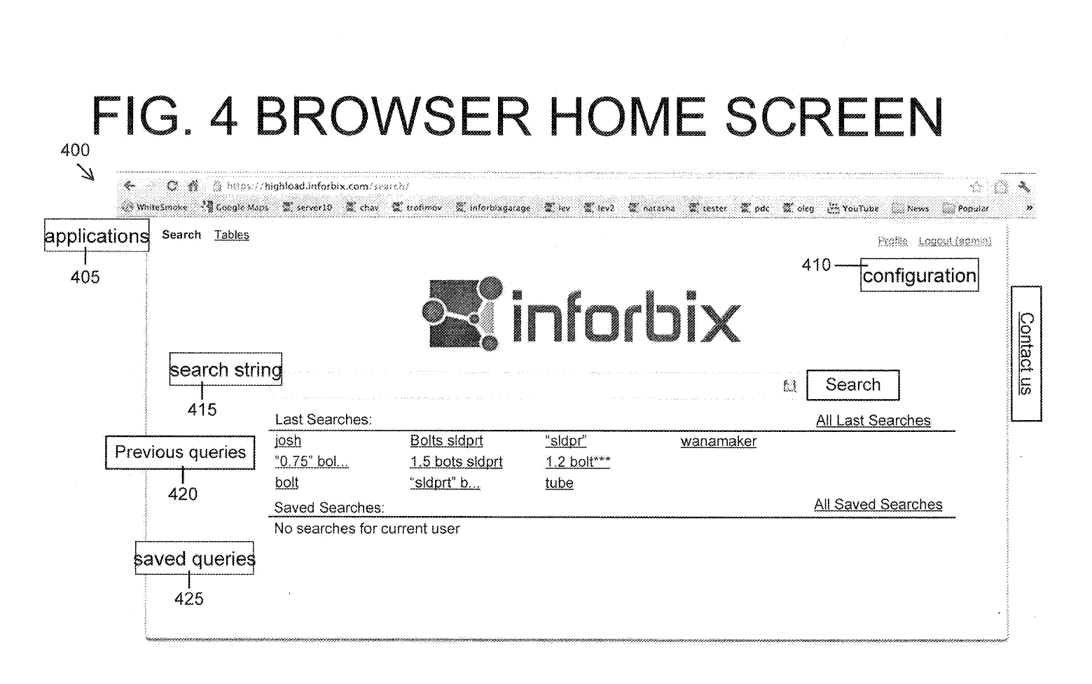

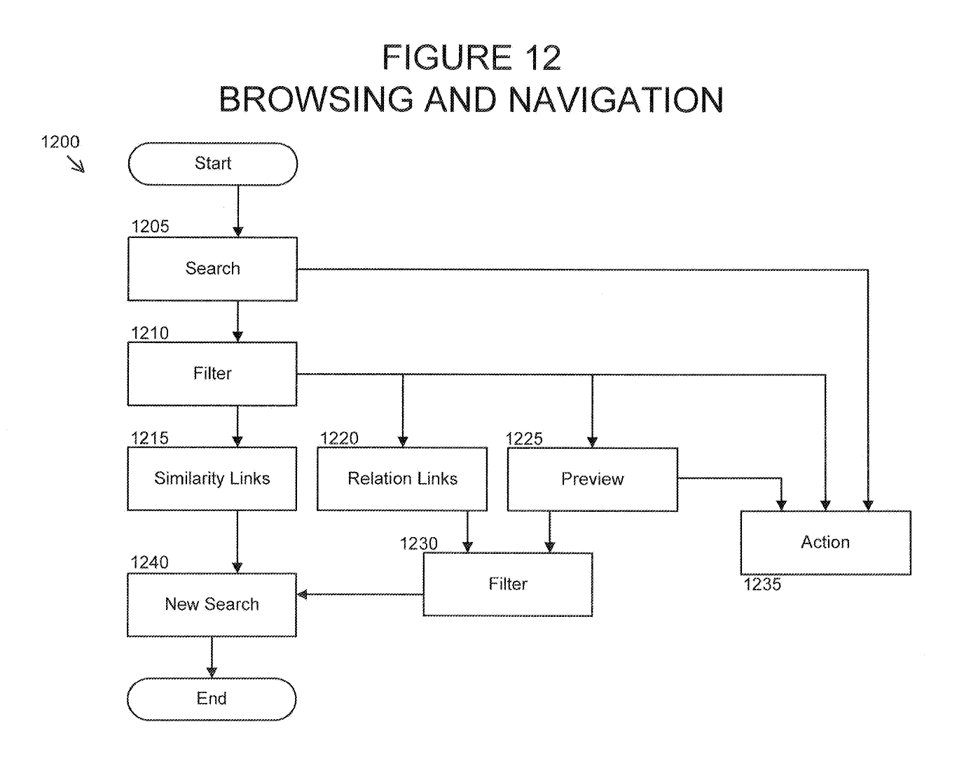

FIG. 12 illustrates a browsing and navigation flowchart 1200, according to an embodiment. In 1205, searching can be done. For example, search string criteria (e.g., a keyword or set of keywords) can be entered and a search can be performed (see FIG. 4, described below). A resulting list of snippets can be presented to the user based on indexing mechanism. The list of snippets can be sorted by search relevance.

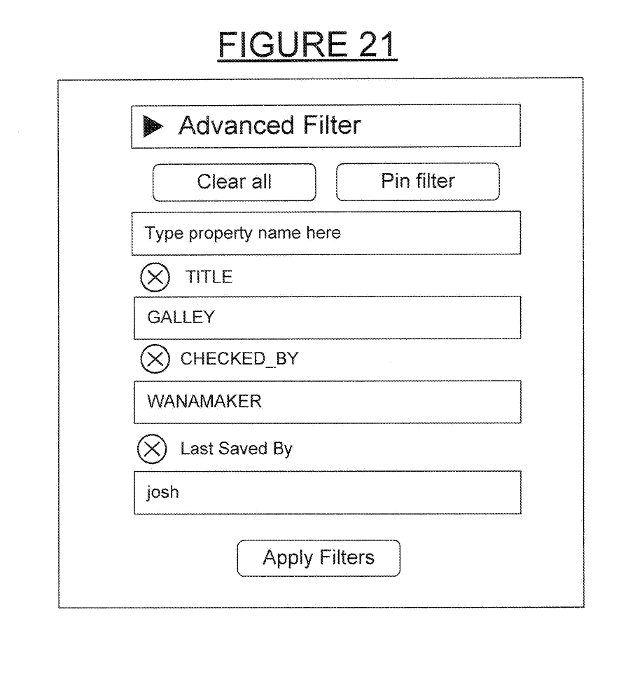

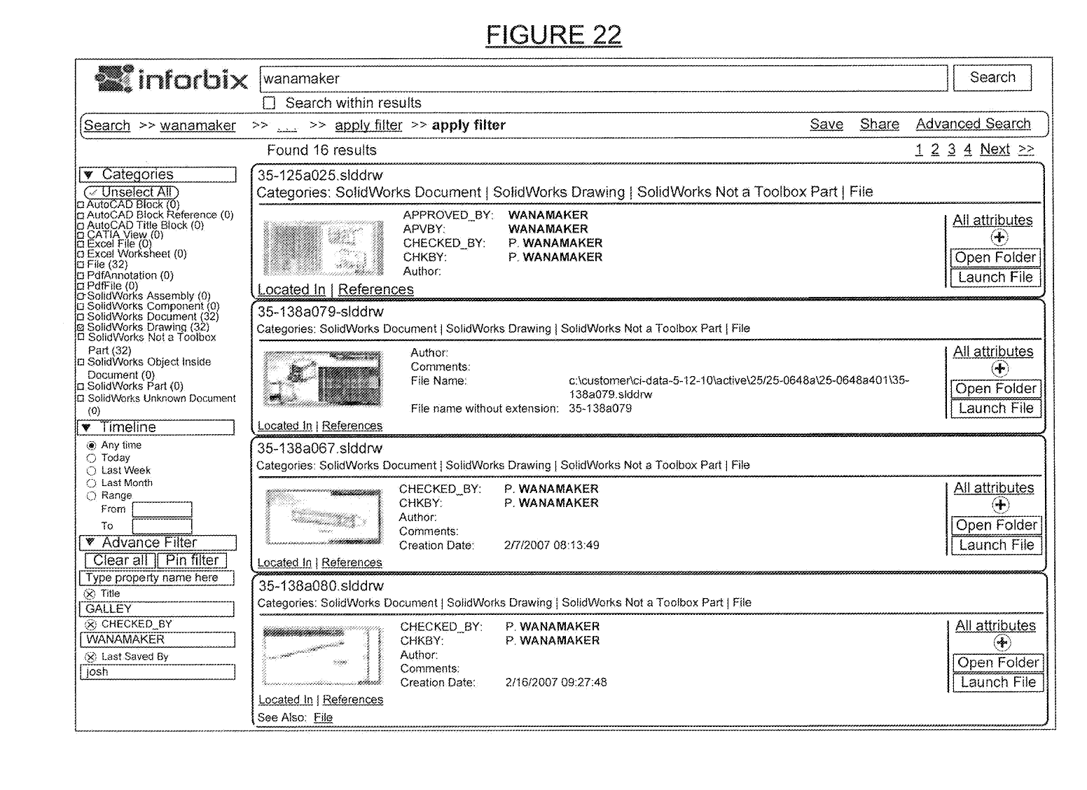

In 1210, filtering can be done. Filtering can reduce a number of snippets in result set. There are multiple filtering options, including, but not limited to: categories, time line, or advanced filtering, or any combination thereof. Categories allow to user to filter the snippets using the categories (i.e. SOLIDWORKS Parts, SOLIDWORKS Drawings). Time line allows a user to filter using time information. Advanced filtering (shown in FIG. 21) can allow filtering using various categories, with search information entered for the various categories. A pin filter can allow additional searching while applying the previous filter information. FIG. 22 is an example of a screen that can be shown when advanced filtering similar to that of FIG. 21 is applied.

In 1215 and 1220, links can be accessed. The links can represent connectivity between snippets. By accessing these links, the user can easily navigate between multiple snippets.

In 1225, preview information for an object can be shown. In 1235, an action can be taken related to a snippet. An action can allow a user to activate external applications (e.g., CAD system, text editor, enterprise system), and connect product information and external applications together. In addition, a user can perform the action of saving queries and fusion tables, including all filtering criteria. Query definitions can be saved and/or shared, and users can be allowed to access updated information. Custom actions can also be allowed. An administrator/user can set up these actions (e.g., running Java scripts or connecting to or using a particular application).

In 1230, additional filtering can be done. In 1240, additional searching can be done, if needed.

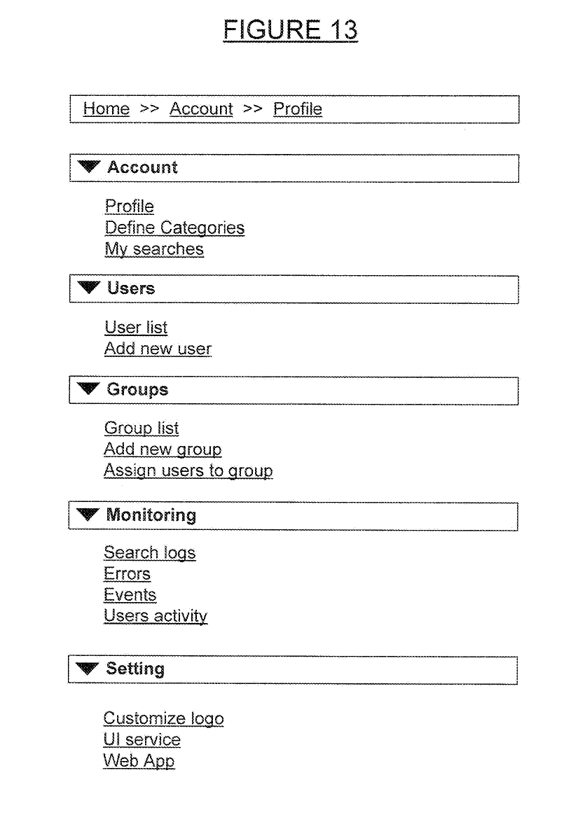

FIGS. 4-11 and 12-24 illustrate various screens that can be utilized, according to an embodiment. FIG. 4 illustrates a browser home screen 400, according to an embodiment. The user can use this browser home screen 400 to enter a search string 415 to search to find relevant pieces of data (e.g., objects) based on text search methods. The browser home screen 400 can also be used to access saved queries 425 and/or previous queries 420. In some embodiments, saved queries 425 and/or previous queries 420 can be shared with others. Configuration parameters 410 can also be accessed. For example, profile information can be accessed. FIG. 13 is an example list of configuration parameters. Browser home screen 400 can also illustrate various applications 405. For example, a search option and/or a table option may be shown. FIG. 4 illustrates the search option.

FIG. 5 illustrates a snippet browser screen 500, according to an embodiment. This snippet browser screen 500 can appear once a search is performed using the screen shot in FIG. 4. The snippet browser screen 500 can allow simultaneous access to interconnected pieces of information located in multiple data systems. As in FIG. 4, snippet browser screen 500 can also illustrate various applications 405 (e.g., search option and/or table option), configuration parameters 410, and a search string 415. In some embodiments, existing queries may be displayed.

FIG. 5 also illustrates a historical navigator 510, which can include information about the search (e.g., josh), and/or any applied filters. Searches and/or filtering can be saved 520, and shared 540 with others. Structured snippets 525, which can be found using the search string 415, can be illustrated. Displaying data in the structured snippets 525 can allow multiple facets of information to be combined into a single meaningful information source. The structured snippets 525 can be filtered using the filtering 515, where certain categories can be checked, and only the structured snippets 525 that meet those categories can be shown. Advanced searching 525 (as described above with respect to FIG. 21) can also be done. Navigation can be performed using links, which can represent dependencies between the information located in the multiple systems that are searched (e.g., contains, where used, references, bill of materials). Pages 545 can also be shown. Existing queries 505 may be shown.

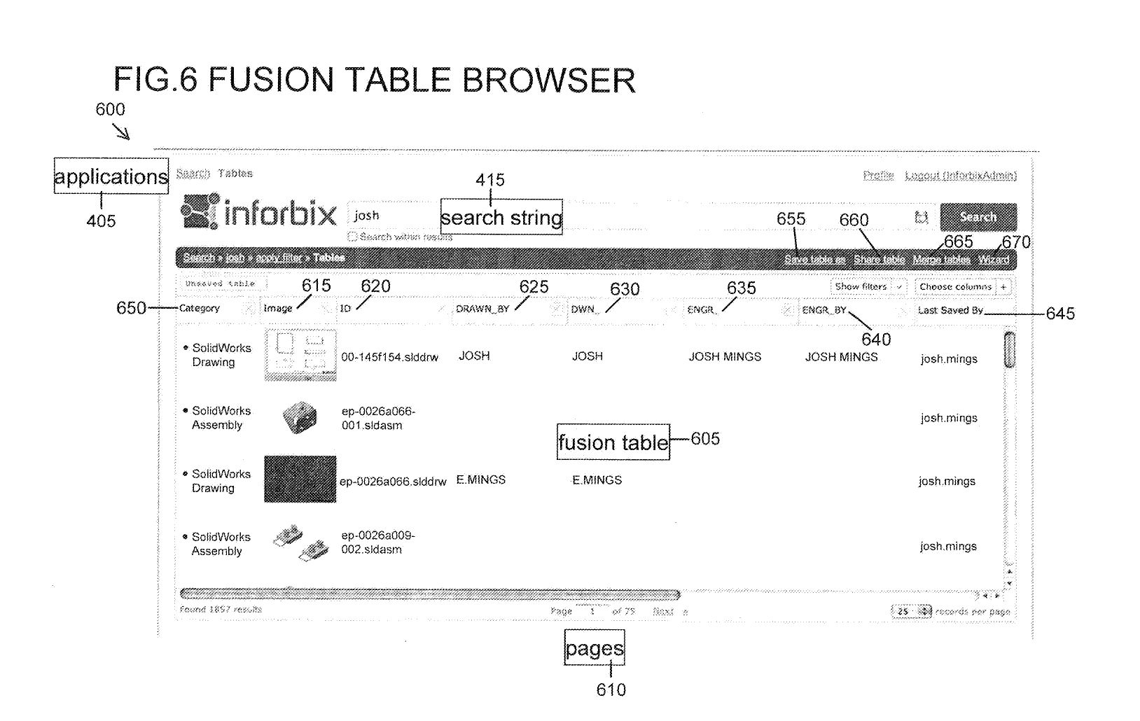

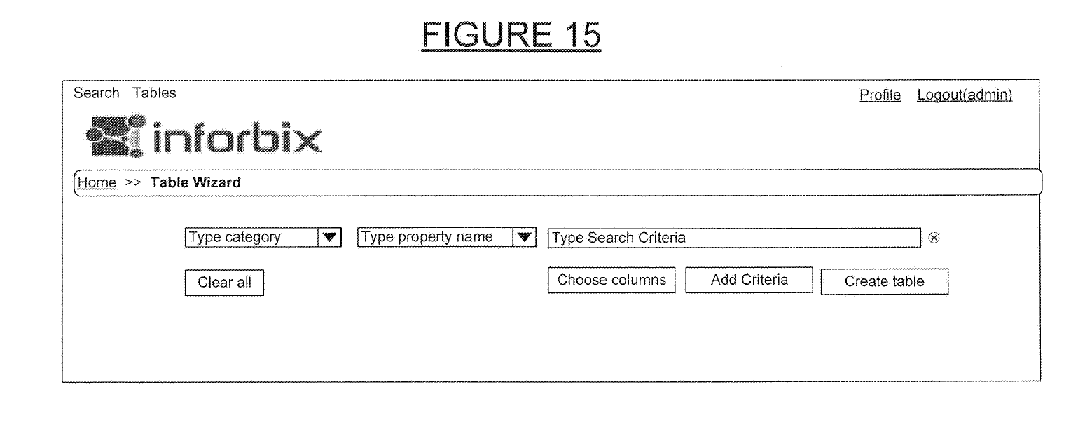

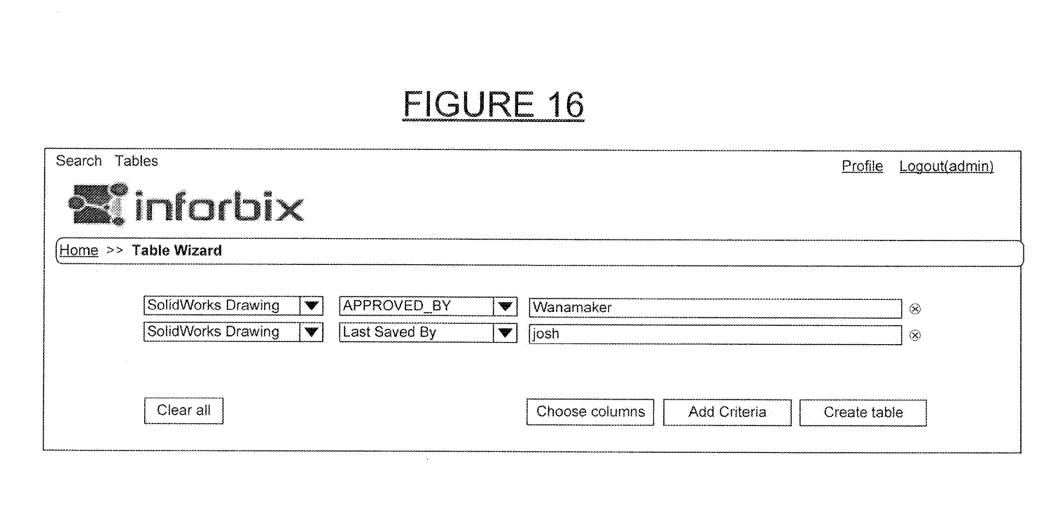

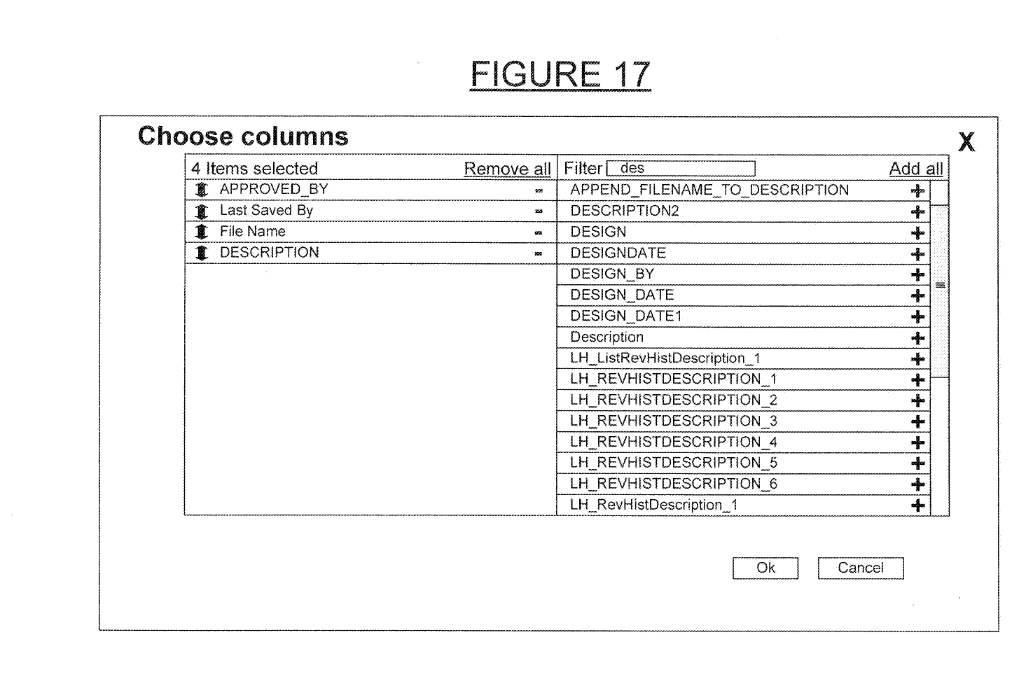

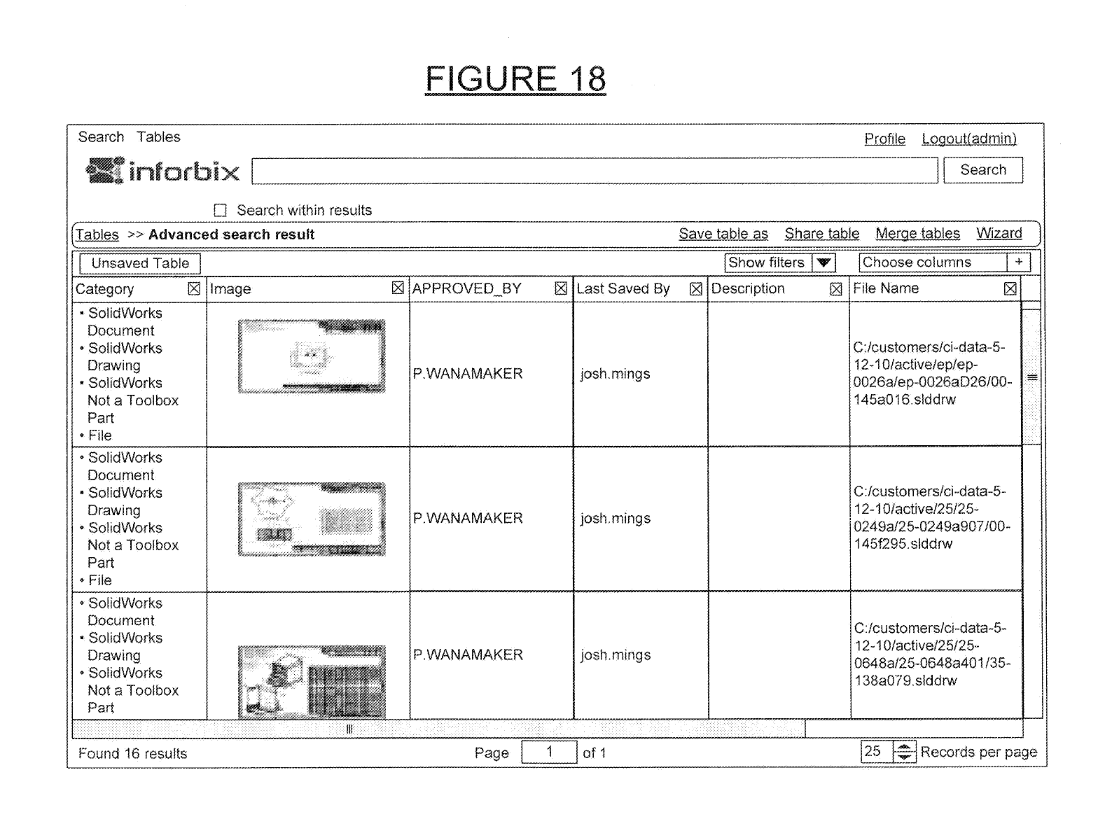

FIG. 6 illustrates a fusion table browser screen 600, according to an embodiment. While FIGS. 4 and 5 illustrated the search application 405, FIG. 6 illustrates the table application 405. Fusion table 605 can allow a user to pull information from disparate data sources (e.g., objects) into a single table using category and attribute information. Fusion table 605 can include various attributes/categories 650 (e.g., IMAGE 615, ID 620, DRAWN_BY 625, DWN 630, ENGR 635, ENGR_BY 640, LAST SAVED BY 645). Of course, many other types of attributes may be utilized. The tables may be saved and accessed 655, shared 660, merged 665, or any combination thereof. In addition, a wizard 670 can be utilized to create the fusion table. For example, the screens illustrated in FIGS. 15-18 can be utilized to create a fusion table. FIG. 15 illustrates an initial search page. FIG. 16 illustrates an initial search page with criteria entered. If, after entering the search criteria, the user chooses the choose columns button on FIG. 16, the user can be taken to FIG. 17. FIG. 17 can illustrate all possible column names (e.g., on the right side of FIG. 17), which can include attributes. A user may copy any attributes that are important from the right side of FIG. 17 to the columns side (e.g., left side) of FIG. 17, and these attributes may be used to create the fusion table. FIG. 18 illustrates a fusion table that may be created using the columns (e.g., attributes) chosen in FIG. 17. Pages 610 can also be shown.

It should be noted that system 100 allows a user to switch between the snippet configuration shown in FIG. 5 and the table configuration shown in FIG. 6. This may be done by accessing a link at the top of each of these screens. Navigation between these configurations can help a user easily access multiple types of data. For example, a user may find a snippet of a SOLIDWORKS 3D model used in design/engineering. The user may wish to find more information about this model by navigating to AutoCAD drawing used by manufacturing, and then navigating to PDF files sent to an outsource company in China.

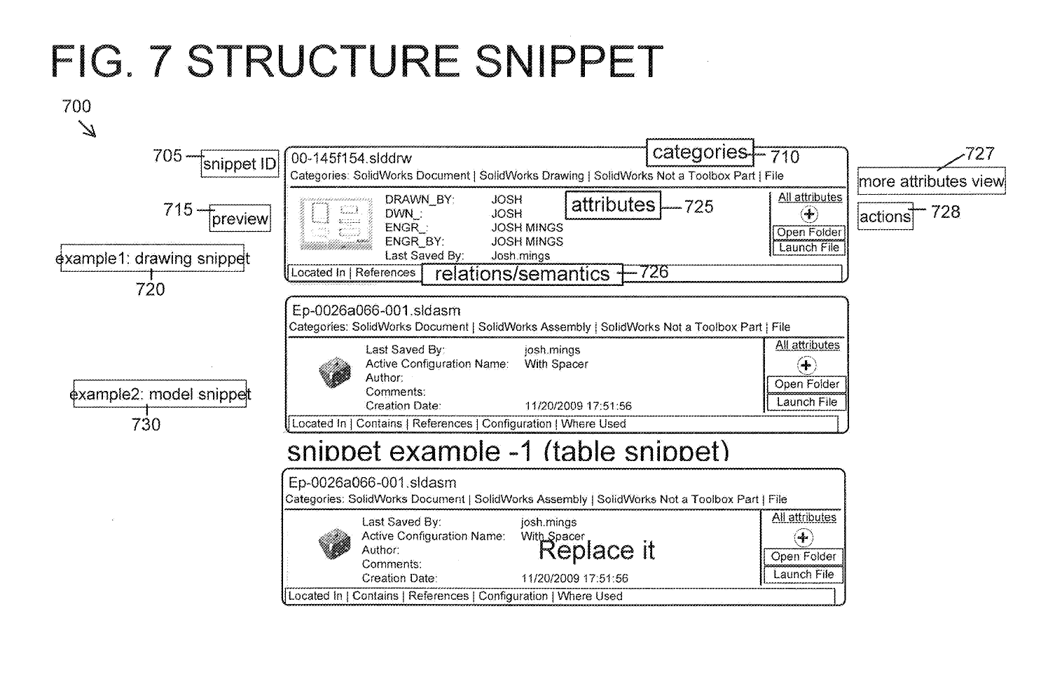

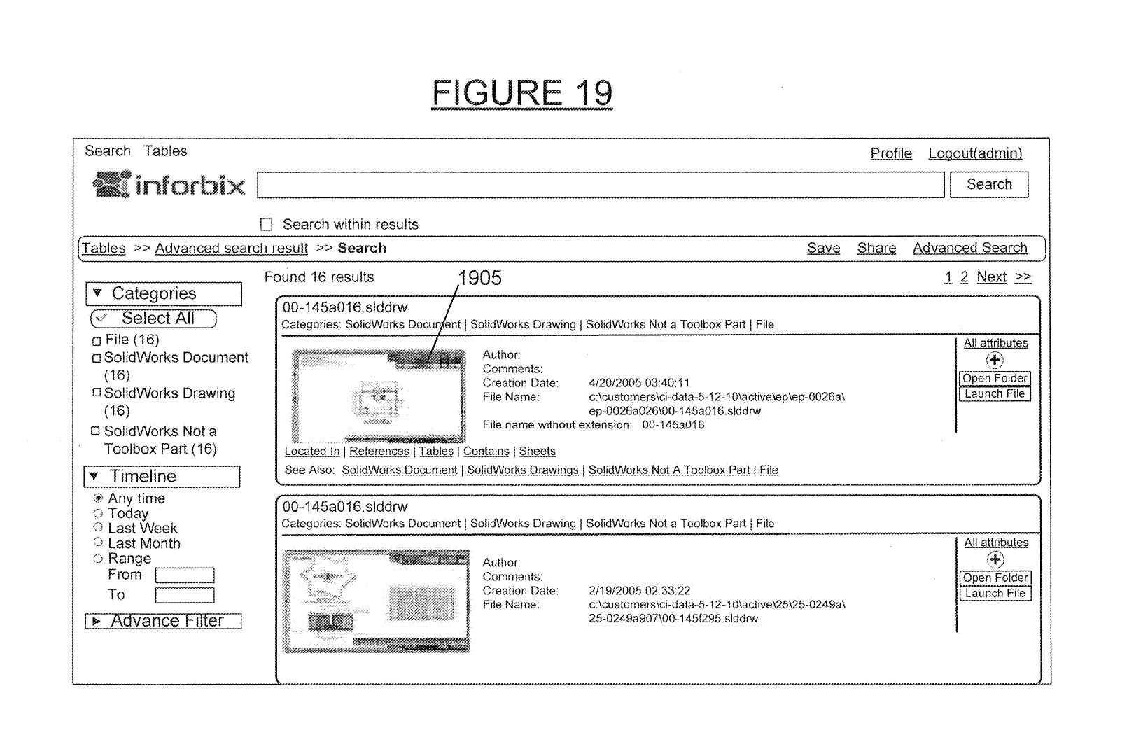

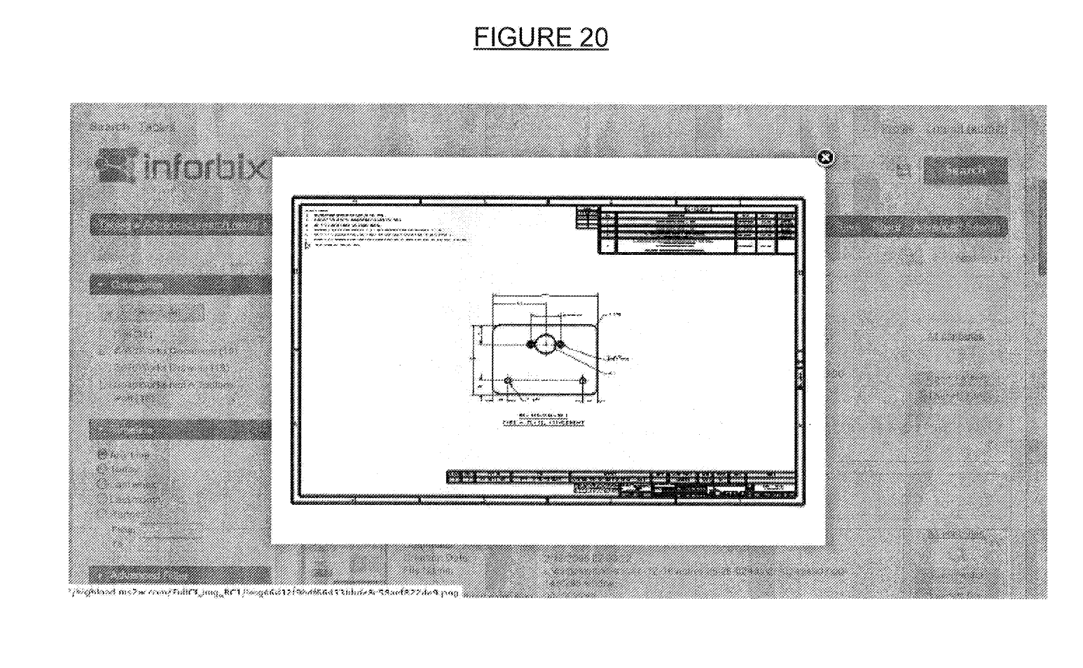

FIG. 7 illustrates a structured snippet 700, according to an embodiment. A sniped ID 705 can be shown. In addition, a preview 715 can also be shown. A drawing snippet 720 is a snippet of a drawing. A model snippet 730 is a snippet of a 3D model. For example, FIG. 19 can show a screen with two snippets, each of which includes a preview option 1905. When the user accesses the preview option 1905, this image can be enlarged, as shown in FIG. 20. Categories 710 may also be utilized (e.g., document, drawing, assembly). Attributes 725 can also be shown. More attributes 727 can also be viewed. Structural relations and/or semantic links 726 can also be accessed. For example, located in information and/or reference information can be accessed. Action 728 (e.g., open folder, launch file) can also be accessed.

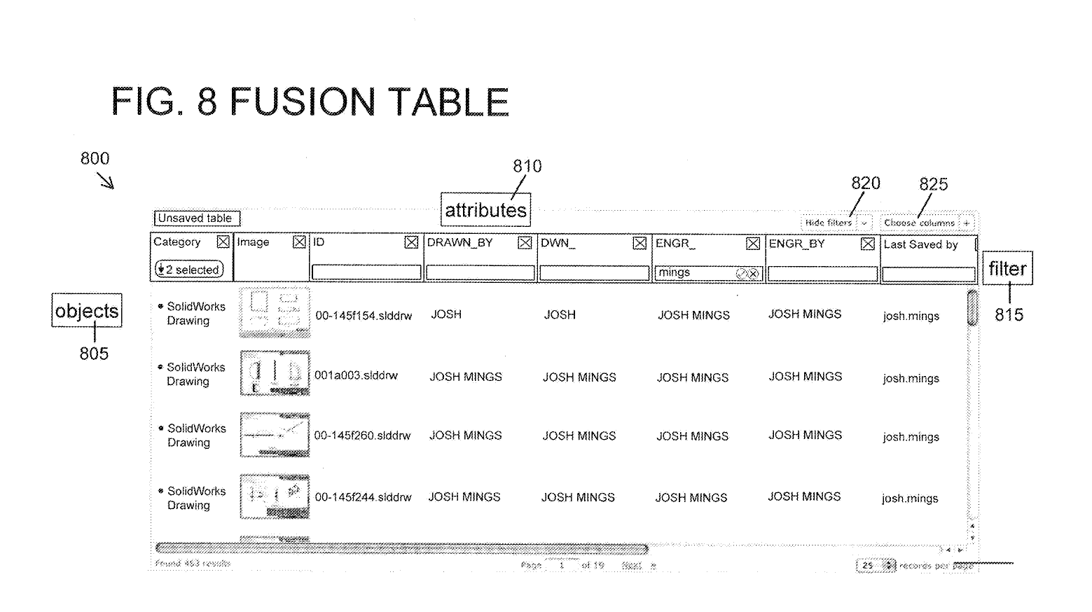

FIG. 8 illustrates a fusion table screen 800, according to an embodiment. Multiple attributes 810 for various objects 805 can be displayed (e.g., category, image, ID, drawn by, dwn, engr, engr by, last saved by). The objects can be filtered 815 using criteria entered for the various attributes. The filters can be hid or displayed 820. The columns may also be chosen according to different configurations 825.

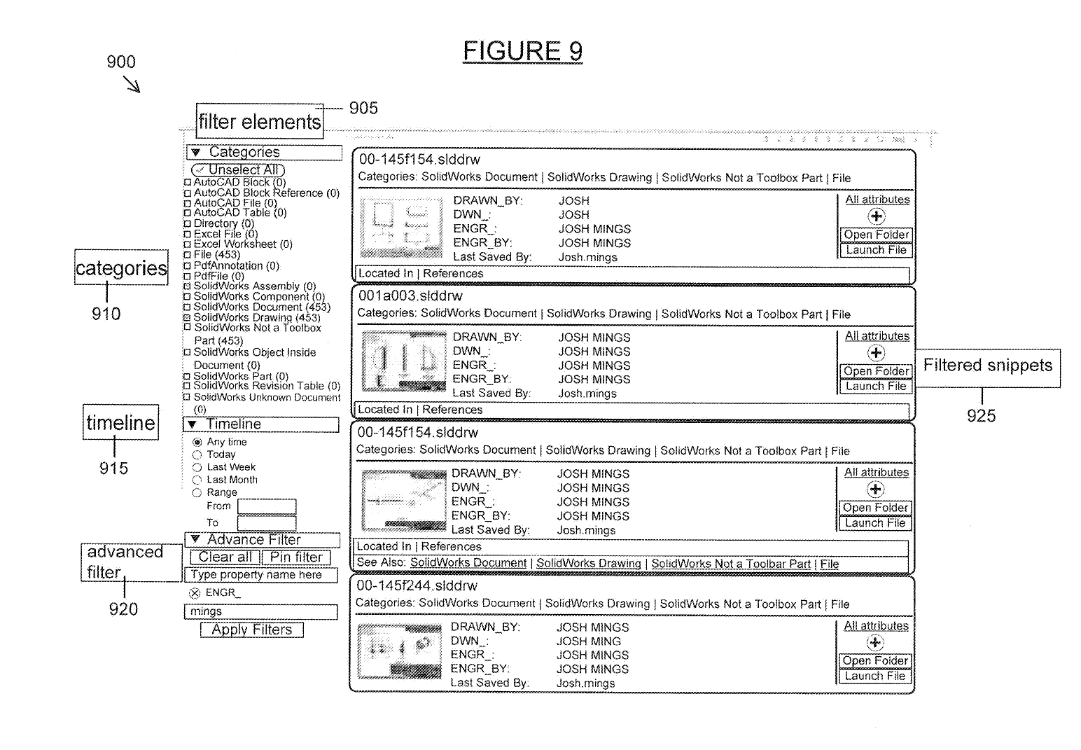

FIG. 9 illustrates a query result and filtering screen 900, according to an embodiment. This screen illustrates how a structured snippet query can be defined, saved, filtered, and shared using information categories, criteria and filters. Filter elements 905 can be shown: categories 910, timeline 915, or advanced filters 920, or any combination thereof. The filtered snippets 925 can be displayed on the right side of the screen.

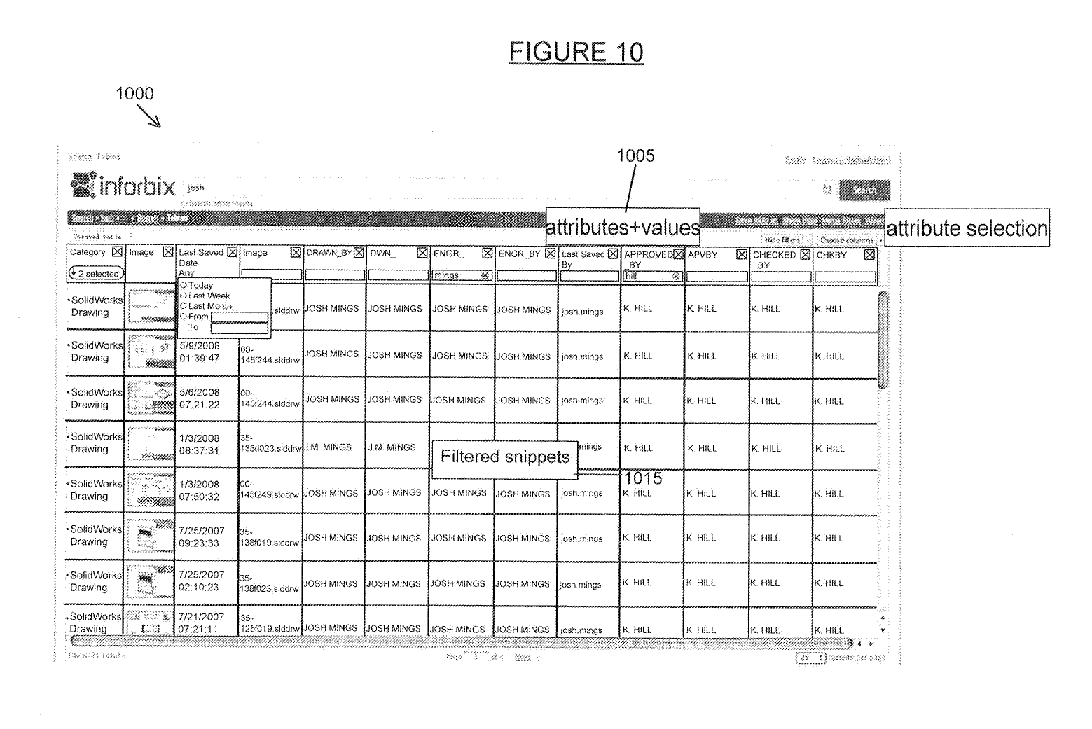

FIG. 10 illustrates a table query result and filtering screen 1000, according to an embodiment. This screen illustrates how a fusion table can be defined, saved, filtered, and shared using information categories, columns, and filters. The attributes 1005 are displayed at the top of the screen. The filters can be hid or displayed 820. The columns (e.g. showing attributes) may also be chosen according to different configurations 825. The filtered snippets 1015 can then be displayed.

FIG. 11 illustrates example table snippets, according to an embodiment. The table snippets may show a user why certain search results show up in, for example, a fusion table. In 1105, a table snippet is shown. In this example, the snippet ID is “hr-0002a001r08: Accrual Summary”. The table snippet 1105 shows excerpts from this Accrual Summary document. The user may choose to “view table”, which will take the user to a preview of the Accrual Summary. Or the user may choose to “create table”, which will create a fusion table similar to the one shown in FIG. 6. In 1110, another table snippet is shown. In this example, the snippet ID is “list of we from pdm: Sheet 1”. The table snippet 1110 shows excerpts from this document. As with the table snippet 1105, a user may choose a “view table” or “create table” option in table snippet 1110.

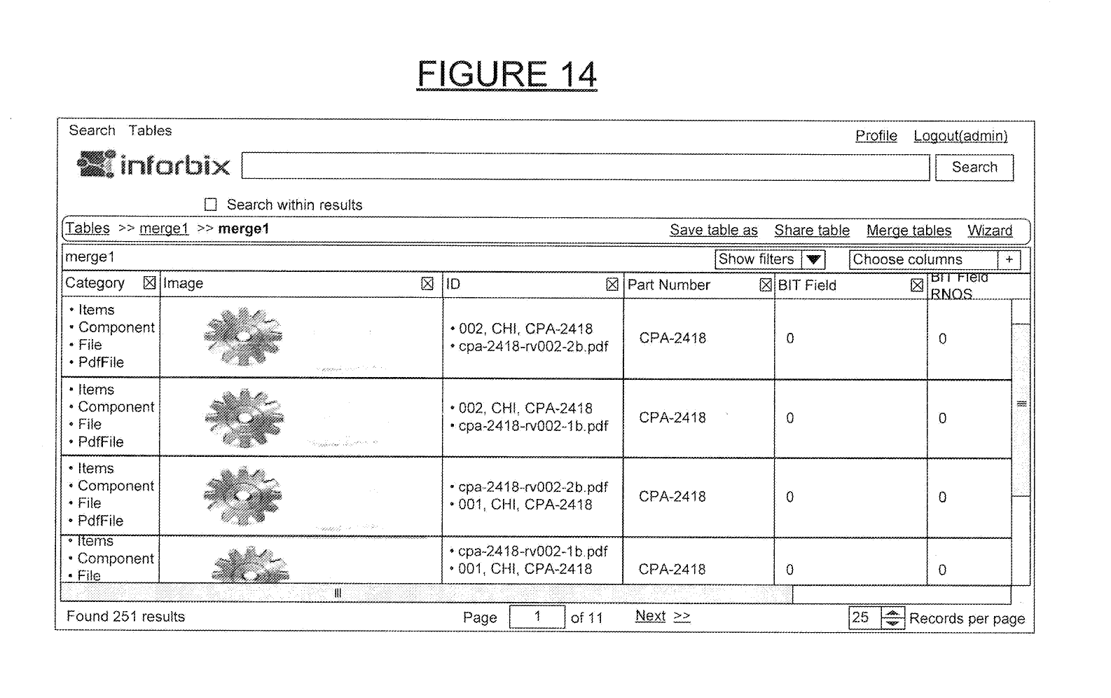

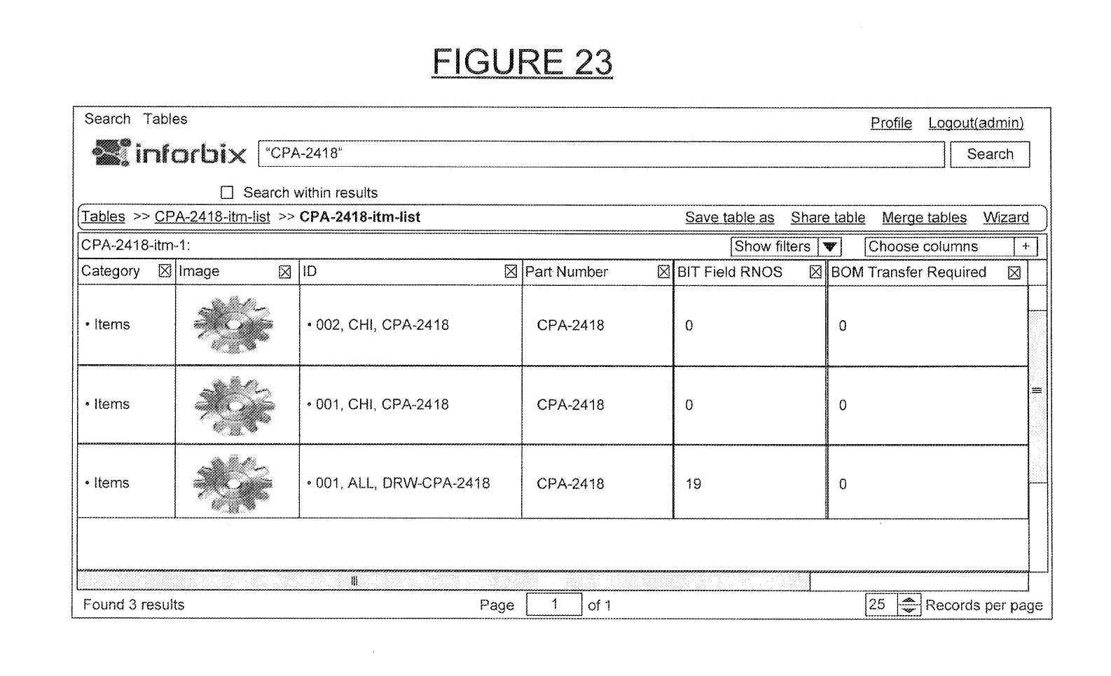

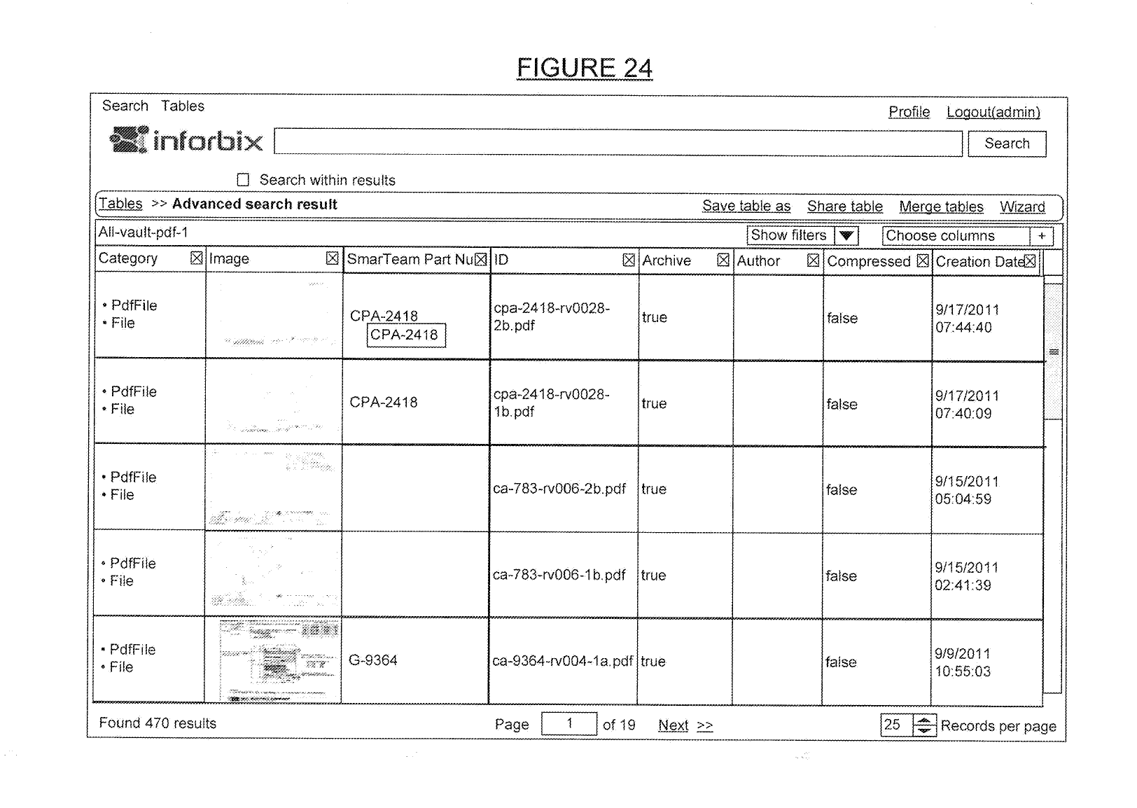

FIG. 14 illustrates a fusion merger screen, according to an embodiment. This screen shows how multiple fusion tables (e.g., from different systems, such as a design system and a manufacturing/cost system) can be merged together using a common set of attributes. For example, FIG. 23 illustrates a table with several objects that are parts coming out of an engineering system. FIG. 24 illustrates a second table with several objects of PDF files/Drawings coming out of an information system that includes released (shipped) product information. The merged table in FIG. 14 can provide information combined from the tables in FIGS. 23 and 24 for easy data visualization and browsing, so user can see information from both system combined. If there are any matching attributes for the objects in FIG. 23 and FIG. 24 (e.g., the part number is the same), the information from both the table in FIG. 23 and the table in FIG. 24 (e.g., related to that same part number) may be merged into the table in FIG. 14. The merging may combine the information in both tables, take out any duplicative information, and display the remaining information.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages, are presented for example purposes only. The disclosed methodology and system are each sufficiently flexible and configurable, such that it may be utilized in ways other than that shown. For example, the steps listed in any flowchart may be re-ordered or only optionally used (even when not explicitly indicated) in some embodiments. Thus, those skilled in the art will realize that the ordering of the steps of the figures can be altered in other embodiments and that various steps can be removed in some embodiments.

It should also be noted that Applicant has, for consistency reasons, used the phrase “comprising” throughout the claims instead of, or in addition to, “including, but not limited to”. However, it should be noted that “comprising” should be interpreted as meaning “including, but not limited to”.

In addition, it should also be noted that, if not already set forth explicitly, the term “a” should be interpreted as “at least one” and “the”, “said”, etc. should be interpreted as “the at least one”, “said at least one”, etc.

It should also be noted that the purpose of any Abstract of the Disclosure, Summary, or Background section is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure, Summary, or Background section are not intended to limit the scope of the invention in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

1. A method for creating at least one structured snippet, comprising:
performing processing associated with extracting data from multiple sources for at least one entity;
performing processing associated with stitching the data together based on the semantic attributes of the data to create at least one structured snippet; and
performing processing associated with suggesting at least one action or allowing at least one user to define at least one action related to the at least one structured snippet.

2. The method of claim 1, wherein the stitching is done utilizing information from at least one manufacturing company, and comprises determining:
at least one design;
at least one structure of at least one design;
price information on at least one product;
price information on at least one part of at least one product;
at least one structure of at least one design; or
at least one part number of at least one design; or
any combination thereof.

3. The method of claim 1, wherein the stitching, is done by utilizing at least one piece of data in at least one application to search in at least one other application.

4. The method of claim 3, wherein the searching comprises:
statistical searching;
mathematical searching; or
word searching; or
any combination thereof.

5. The method of claim 1, wherein the at least one action comprises:
set task;
send entail;
perform validation;
open folder;
start application;
custom action;
send document; or
compare data; or
any combination thereof.

6. The method of claim 1, wherein triple indexing is utilized to create the at least one structured snippet.

7. The method of claim 1, wherein advanced searching is utilized with the at least one structured snippet.

8. A method of creating at least one product data table, comprising:
performing processing associated with extracting product data from multiple sources;
performing processing associated with stitching the data together; and
performing processing associated with presenting the data in at least one table, wherein the at least one table comprises at least one row where at least one object is listed and at least one column listing attributes of the at least one object.

9. The method of claim 8, wherein the product data comprises words or pictures or both.

10. A system for creating at least one structured snippet, comprising:
a processor configured for:
performing processing associated with extracting data from multiple sources for at least one entity;
performing processing associated with stitching the data together based on the semantic attributes of the data to create at least one structured snippet; and
performing processing associated with suggesting at least one action or allowing at least one user to define at least one action related to the at least one structured snippet.

11. The system of claim 10, wherein the stitching is done utilizing information from at least one manufacturing company, and comprises determining:
at least one design;
at least one structure of at least one design;
price information on at least one product;
price information on at least one part of at least one product;
at least one structure of at least one design; or
at least one part number of at least one design; or
any combination thereof.

12. The system of claim 10, wherein the stitching is done by utilizing at least one piece of data in at least one application to search in at least one other application.

13. The system of claim 10, wherein the searching comprises:
statistical searching;
mathematical searching; or
word searching; or
any combination thereof.

14. The system of claim 10, wherein the at least one action comprises:
set task;
send email;
perform validation;
open folder;
start application;
send document; or
compare data; or
any combination thereof.

15. The system of claim 10, wherein triple indexing is utilized to create the at least one structured snippet.

16. The method of claim 1, wherein advanced searching is utilized with the at least one structured snippet.

17. A system of creating at least one product data table, comprising:
a processor configured for:
performing processing associated with extracting product data from multiple sources;
performing processing associated with stitching the data together; and
performing processing associated with presenting the data in at least one table, wherein the at least one table comprises at least one row where at least one object is listed and at least one column listing attributes of the at least one object.

18. The system of claim 17, wherein the product data comprises words or pictures or both.
